(19) United States
(12) Patent Application Publication
(10) Pub. No.: US 2014/0049128 A1
(43) Pub. Date: Feb. 20, 2014

(54) Permanent Magnet Electrical Machinery

(71) Applicant: Minghua Zang, Xian (CN)

(72) Inventor: Minghua Zang, Xian (CN)

(21) Appl. No.: 13/957,458

(22) Filed: Aug. 2, 2013

Related U.S. Application Data
(60) Provisional application No. 61/683,683, filed on Aug. 15, 2012.

(51) Int. Cl. H02K 1/06

(52) U.S. Cl. CPC H02K 1/06; H02N 11/008
USPC 310/152; 74/DIG. 9

(57) ABSTRACT

The invention is the permanent magnet electrical machinery that does not need any other energy and can be used as an electromotor or a generator. It consists of a shell that installed with iron cores, coils, principal axis, switches and a control circuit. The 3 coils are circled in the middle, top and bottom part of the stator core separately. The rotor core has leafs and each leaf has a shape of c, it is made by soft magnetism material and is embed with the magnet on each leaf. When the turning rotor core is entering into the position to face with stator core, electric current is produced in the coil in the middle of stator core. The electric current be exported and passed to the coil on the top and bottom of the next stator core. Its magnetic force of electric current repulses the next rotor core, so the rotor core turns and the machine export electricity continually. The gravitation between the end of the previous leaf of the rotor core and the end of the previous stator core still exists.

### BACKGROUND OF THE INVENTION

The invention is the permanent magnet electrical machinery that can be used as an electromotor or a generator and does not need any other energy.

Now, generators and motors consume a mass of energy resource. The most of the resource come from petroleum and coal, it pollute environment. Clean energy resource, such as sun and wind resource, can hardly be prevalent, because of high cost of equipment.

Base on theory in affix 1 and affix 2 (see following paragraph), the permanent magnet electrical machinery is designed to eliminate the impact of counterforce by the principle that the magnetic flux of reverse magnetic field changes gradually in soft magnetic material, it does not cancel out.

### (Affix1) Research on the Principle, Model and Example of Non-Conservative Mechanical Energy

The mechanical energy conservation law is not only proved by theory, but also proved by practice. But when using the mechanical energy conservation law, we doubt about heat death it rising. The misgivings bring the new thought about the mechanical energy conservation law. Start with the premise of mechanical energy conservation law, investigate preconditions of its tenability theoretically; probe into the theory of non-conservative mechanical energy; bring forward physical model of non-conservative mechanical energy; analyze an example of non-conservative mechanical energy in the nature.

There are two preconditions of the mechanical energy conservation law. One is the force and counterforce law, another one is the conservative force field. When two moving objects acting on each other, the force and counterforce law is the precondition of the mechanical energy conservation law. When one moving object in conservative force filed, the property of conservative force filed is the precondition of the mechanical energy conservation law.

Since there are two preconditions for the mechanical energy conservation law, if its preconditions do not meet, the mechanical energy conservation law can not be proved.

First, when two moving objects acting on each other, due to the force and counterforce law, and because the force, time and distance of interactional force are equal, but direction is opposite, so mechanical energy is constant. But, when two moving objects acting on each other, or at end of the acting, the kinetic energy of either one translates into another kind of energy (example: heat), or the energy be blocked, while the systemic energy dos not change, its systemic mechanical energy (kinetic energy) is changed. This means the energy to outside system has changed. The change is the result of internal force; this is significant to non-conservative mechanical energy. In a container there are two objects having the same velocity, and the same mass but opposite direction. The momentum and kinetic energy of the system is zero. But if the kinetic energy of either one translates into the another kind of energy (example: heat), or the energy be blocked, the mechanical energy (kinetic energy) will be inconstant. The kinetic energy of the system is not zero. The system has the energy to outside. In a system with many moving objects, as long as unbalanced mechanical energy change takes place, or the mechanical energy is controlled in unbalanced direction, internal force will become work force, this is a precondition to non-conservative mechanical energy, and this is also the case that the force and counterforce law does not work (see FIG. 4).

In FIG. 5, big molecule gas is isolated by the two sieves (2) between them, because the hole size of the sieves, it only allow the tiny molecule of liquid to pass, does not allow the big molecule of gas to pass. Under the pressure of gas, liquid pass the bottom sieve and rise to the top sieve (potential energy increase). When liquid pass the top sieve, it congeals, falls and releases energy. As the process continued, energy releases continued. The reason for this is that upward pressure is obstructed, downward pressure works. It is hard to happen because of friction and adsorption. But, a precondition of non-conservative mechanical energy has been showed, because in a change process of energy, we do not regard to friction and adsorption in the point of the mechanical energy conservation law.

Water can be as high as mountains, its physic principle can be explained by the physic model.

Hereinbefore bring forward theoretic reason of non-conservative mechanical energy by discussing the precondition of the mechanical energy conservation law. There is also an example of the non-conservative force filed.

Raining process has 4 steps, gasification, rise, coagulation and fall. The absorbing energy in gasification step and the ejective energy in coagulation step are equal. Where the potential energy come from? When the vapor rises, two kinds of forces affect it, aerial buoyancy and gravity, the buoyancy is greater than the gravity, the direction of the composition of forces is upward; when the water falls down, the gravity is greater than buoyancy, the direction of the composition of forces is downward. This is an example of the non-conservative force filed.

The same as that there are two preconditions for the mechanical energy conservation law, there are two contrary preconditions for the non-conservative mechanical energy. In a system with many moving objects, the precondition of non-conservative mechanical energy is unbalanced mechanical energy change take place, or the mechanical energy be controlled in unbalanced direction; the non-conservative force filed is another precondition of non-conservative mechanical energy. Because the unbalanced mechanical energy change and the non-conservative force filed are impersonal, non-conservative mechanical energy is impersonal. We have to meet the one of the preconditions of the non-conservative mechanical energy, as we have to meet it of the mechanical energy conservation law, for us to use it.

### (Affix2) the Magnetic Flux of Reverse Magnetic Field Changes Gradually in Soft Magnetic Material

The magnetic flux of reverse magnetic field changes gradually in soft magnetic material. In the FIG. 6, a and b are permanent magnets, c is soft magnetic iron cone. When the magnets flux of two magnets Is equal in the quantity, but opposite in direction, the magnetic flux in soft magnetic material is not

constant, and the reverse magnetic field dos not counteract each other, but it change gradually in soft magnetic material as the fig shows. The gravitation between a magnet and the one end of soft magnetic material dos not change if there is another opposite magnet on the another end of the soft magnetic material. The reason is that the magnetic flux of reverse magnetic field changes gradually in soft magnetic material. This eliminates the force of reverse magnetic field. If reverse magnetic field is brought by the same magnet, it eliminates the counterforce of the magnetic field.

If field density of two reverse magnets is not equal, magnetic flux in soft magnetic material of each magnet will not be equal and dot c will not be in the middle of the soft magnetic material. Here put forward a envisage of the opposite lever: B1/ac=B2/cb; B1 is density of the magnetic flux of the magnet a in soft magnetic material; B2 is the density of the magnetic flux of the magnet b in soft magnetic material; ac is the distance between magnet a and c (0 magnetic flux); cb is the distance between magnet b and c (0 magnetic flux). The soft magnetic material has to be long enough.

### BRIEF SUMMARY OF THE INVENTION

The invention is the permanent magnet electrical machinery that does not need any other energy and can be used as an electromotor or a generator. It consists of a shell that installed with iron cores, coils, principal axis, switches and a control circuit (FIG. 1, FIG. 2).

The shell consists of a top lid, a bottom lid and a shell body. The top lid has a bearing seat, bolt holes and partition girders to lock stator cores. The bottom lid has a bearing seat, bolt holes, partition girders to lock the stator core and the holes for wire. The shell body also has bolt holes on each side to fix the top lid, the bottom lid and itself together. The shell body also has holes on the bottom for wire. The iron cones are consists of stator cores and rotor cores. The stator cores are made by soft magnetic material with the shape of c. The 3 coils are circled in the middle, top and bottom part of the stator core separately. The coil on the top part of the stator core is at the top end of the stator core and can be divided to two parts. The coil on bottom of the stator core is at the bottom end of the stator core and can be divided to two parts. The principal axis is installed in the bearing in the top lid and the bearing in the bottom lid. The principal axis and the rotor cores are integral whole. The rotor core has leafs and each leaf has a shape of c, it is made by soft magnetism material and is embed with a magnet on each leaf that is fixed with no magnetism plate. The magnet can be more and different location. The group switch of two with three positions is consists of start, operation and stop 3 positions. The turning rotor core cause light-operated switch on or off, deciding the coil in the middle of the stator core connect or disconnect to the coil on the top and bottom of the next stator core through the group switch of two with two positions. In the group switch of two with two positions, one switch can connect the coil or only one part of coil on the top of the stator core and the coil in the middle of the stator core; one switch can connect the coil or only one part of coil on the bottom of the stator core and the coil on the top of the stator core. The permanent magnet electrical machinery is started by a battery charged by the permanent magnet electrical machinery itself.

The coil in the middle of the stator core has a distance with the top end of the stator core and with the bottom end of the stator core. The ratio of leafs of the rotor core and stator cores is 2:3 or 3:2. The permanent magnet electrical machinery is operated by electricity that is generated by itself. The permanent magnet machinery can be used as an electromotor or a generator. The permanent magnet electrical machinery can be putted perpendicularly or horizontally by changing the position of the machine seat. Stator cores and leafs of the rotor core can be more. The light-operated switch can be replaced by the electric brushes.

In the scheme, the ratio of the leafs of the rotor core and stator cores is 2:3 or 3:2; the coil in the middle of the stator core can connect or disconnect to the coil on the top and bottom of the next stator core. Another scheme for the number of leafs of the rotor core and number of stator cores is that the number of stator cores is the number of leafs of the rotor core plus 1 or minus 1; the coil in the middle of the stator core can connect or disconnect to the coil on the top and bottom of a stator core decided by a PLC, according to the coil in the middle of the stator core that the rotor core entering to face connected to the coil on the top and bottom of a stator core that the rotor core withdrawing from.

Another scheme for the position of the rotor core and stator cores is to put the rotor core and stator cores horizontally (FIG. 3). The principle of the design is the same. The difference is top and bottom of the stator core and the rotor core become front and rear, as well as coils on them. And front and rear position of the coils of the stator core changes as the rotor core turning. The connection between the middle coil and front and rear coils is controlled by a PLC. The rotor core and magnet are fixed with two no magnetism plates on top and bottom of them. The stator cores with round shape are fixed in the shell by the stator cores seats and bolts on the lids.

The features of the invention are no other energy needed, no pollution, simple structure and economical.

### BRIEF DESCRIPTION OF SEVERAL VIEWS OF THE DRAWING

FIG. 1 is the structural representation and overlook view of the structural representation of the permanent magnet electrical machinery.

The permanent magnet electrical machinery is consists of a shell (1,21,18) that installed with iron cores (3,6), a rotor and a control circuit. The shell (1,21,18) consists of a top lid (1), a bottom lid (18) and a shell body (21). The top lid (1), bottom lid (18) and shell body (21) have bolt holes (23) to fit together. The top lid (1) and bottom lid (18) have partition girder (2) to lock stator core (3). The bottom lid (18) and shell body (21) have group holes (22), each group has 2 holes (22) for the wire of the coil (20,4,19) to connect to the control circuit. The top lid (1) and bottom lid (18) each have a bearing seat (5, 15) to put the bearing (7, 16). The bottom lid has machine seats (12). The stator core (3) is made by soft magnetic material with the shape of c, and is blocked between top lid (1) and bottom lid (18) by partition girders (2) and bolt (10) on each side. There are 3 coils (20, 4, 19) in the middle, top and bottom of the stator core (3) separately. The coil (20) in the middle of the stator core (3) has a distance with the coil (4) on the top part of the stator core (3) and with the coil (19) on bottom part of the stator core (3). The coil (4) on the top part of the stator core (3) is at the top end of the stator core (3) and can be divided to two parts (4a,4b). The coil (19) on bottom part of the stator core (3) is at the bottom end of the stator core (3) and can be divided to two parts (19a,19b). Rotor core (6) is made by soft magnetism material. The rotor is consists of the principal axis (14) and many leafs (6,13). A leaf (6,13) is consists of a rotor core (6) and a magnet (13) embedded in the rotor core (6) and fixed with no magnetism plate (11). The principal axis (14) and the leafs (6,13) are fixed with two no magnetism plate (8,17).

When one leaf (6,13) of the rotor is entering into the position to face with stator core (3), due to the increasing magnetic flux in the stator core (3), electric current is produced in the coil (20) in the middle of stator core (3) and passed to coils (4,19) on the top and bottom of the next stator core (3). Its magnetic force of electric current repulses the leaf that face to face with it, so the leaf turns continually and the permanent magnet electrical machinery export electricity passing through the voltage stabilizer (26) continually.

FIG. 2 is a circuit of the permanent magnet electrical machinery of one pair of the coils (20,4,19) in the middle of the stator core (3) and on the top and bottom of the stator core (3). But, because other pairs of the coils (20,4,19) in the middle of the stator core (3) and on the top and bottom of the stator core (3) are parallel connected in the circuit through light-operated switch (9), FIG. 2 is the circuit of the permanent magnet electrical machinery.

The circuit is consists of a group switch of two (25a,25b) with three positions, a group switch of two (27a,27b) with two positions, a light-operated switch (9), a coil (20) in the middle of the stator core (3), a series-wound coils (4,19), three independent switches (28,29,31), electrical appliance, a battery (32) and a voltage stabilizer (26). The series-wound coils (4,19) is consists of the coil (4) on the top part of the stator core (3) and the coil (19) on bottom part of the stator core (3). The coil (4) on the top part of the stator core (3) is at the top end of the stator core (3) and can be divided to two parts (4a,4b). The coil (19) on bottom part of the stator core (3) is at the bottom end of the stator core (3) and can be divided to two parts (19a,19b).

To start the permanent magnet electrical machinery, turn the group switch of two (25a,25b) on the start (top) position, this means the group switch of two (25a,25b) turn-on the battery (24) position; turn the group switch of two (27a,27b) on the top position; turn switch (31) on. When one turning leaf of the rotor is entering into the position to face with stator core (3), it turn-on the light-operated switch (9), connecting the battery (32) and the series-wound coils (4,19) on the top and bottom of the next stator core (3) through the group switch of two (27a,27b). The rotor run by the magnetic force of the coils (4,19) on the top and bottom of the next stator core (3) that face to face with the leaf of the rotor.

To operate the permanent magnet electrical machinery as a generator after it starts, turn the group switch (25a,25b) on to the operation (middle) position; turn the group switch of two (27a,27b) on the generator (bottom) position; turn switch (29) on. When one leaf (6,13) of the rotor is entering into the position to face with stator core (3), due to the increasing magnetic flux in the stator core (3), electric current is produced in the coil (20) in the middle of stator core (3) (at the same time, the series-wound coils (4,19) on the top and bottom of the same stator core (3) are disconnected to the circuit), the direction of its magnetic flux is opposite to that of the magnets (13). Due to the magnetic flux of reverse magnetic field changes gradually in soft magnetic material (affix 2), the gravitation between the end of the leaf (6,13) of the rotor and the end of the stator core (3) still exists. At the same time, the light-operated switch (9) is on, the group switch of two (27a,27b) connect to one part of coil (4b,19b) on the top and bottom of the next stator core (3); its magnetic force of the electric current repulses the leaf (6,13) of the rotor that face to face with it, so the rotor turns continually and export electricity to electrical appliance (32) continually.

To operate the permanent magnet electrical machinery as a motor after it starts, turn the group switch (25a,25b) on to the operation (middle) position; turn the group switch of two (27a,27b) on the motor (top) position; turn switch (28) on. When one leaf (6,13) of the rotor is entering into the position to face with stator core (3), due to the increasing magnetic flux in the stator core (3), electric current is produced in the coil (20) in the middle of stator core (3) (at the same time, the series-wound coils (4,19) on the top and bottom of the same stator core (3) are disconnected to the circuit), the direction of its magnetic flux is opposite to that of the magnets (13). Due to the magnetic flux of reverse magnetic field changes gradually in soft magnetic material (affix 2), the gravitation between the end of the leaf of the rotor and the end of the stator core (3) still exists. At the same time, the light-operated switch (9) is on, the group switch of two (27a,27b) connect to the coil (4,19) on the top and bottom of the next stator core (3), its magnetic force of the electric current repulses the leaf of the rotor that face to face with it, so the rotor turns continually.

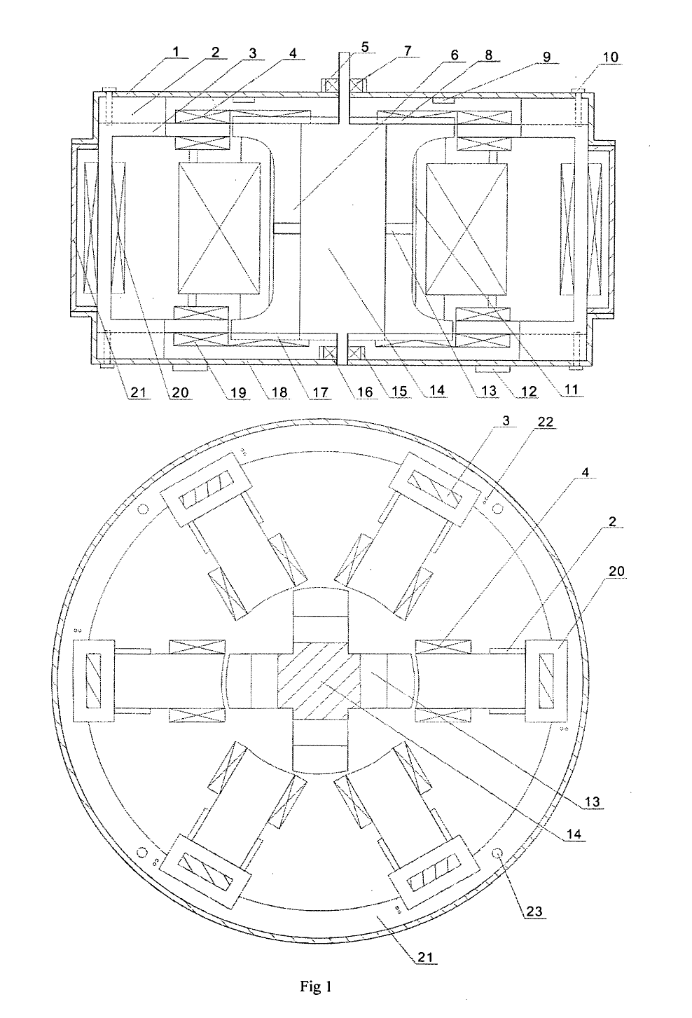

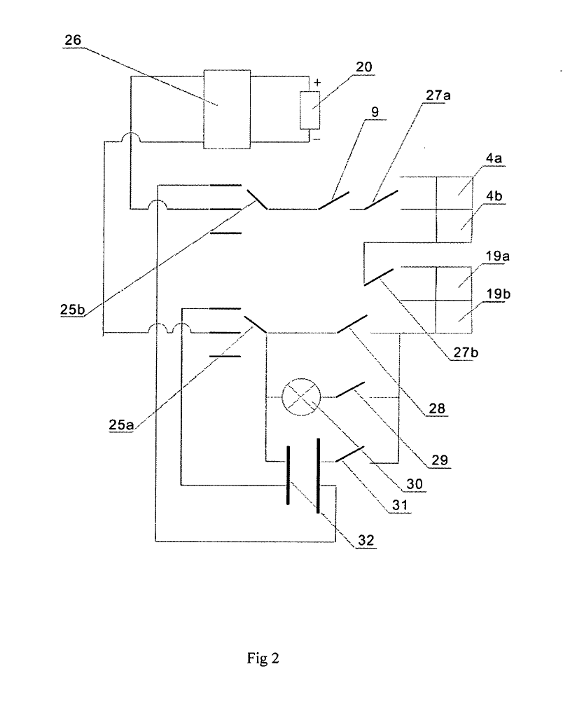

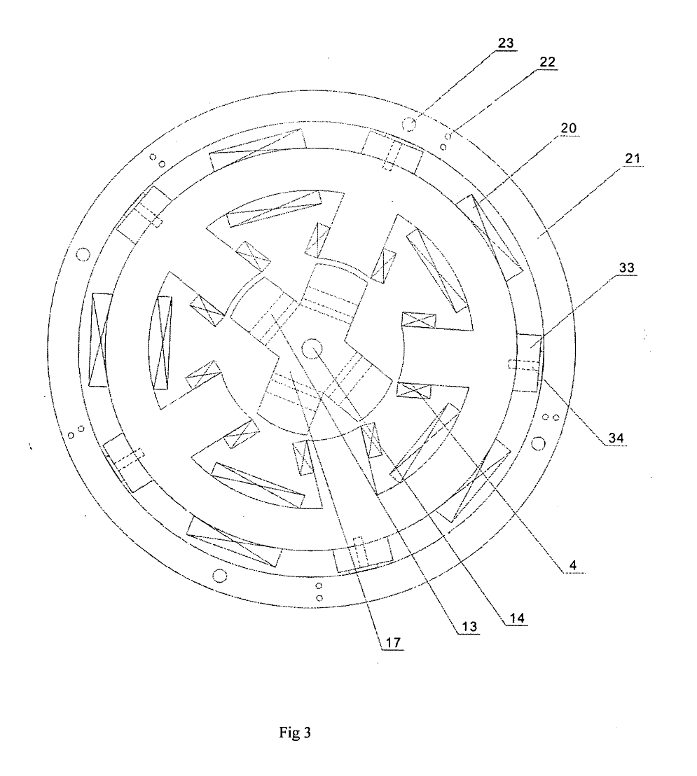

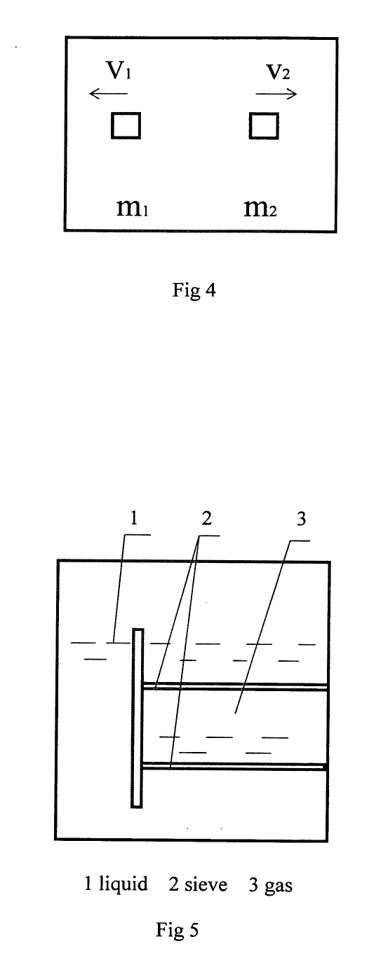

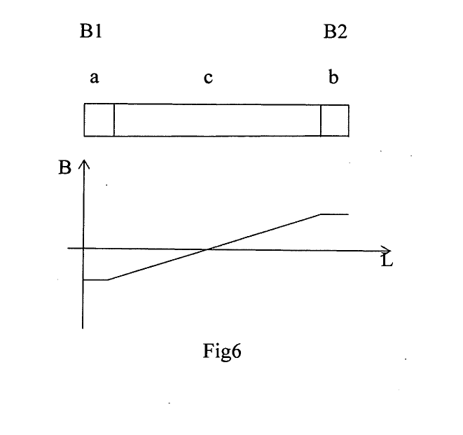

FIG. 3 is the structural representation of the plate shape permanent magnet electrical machinery (use the same mark for the same part with FIG. 1 and FIG. 2).

The only difference of the plate shape permanent magnet electrical machinery is to put the leaf (6,13) of the rotor and stator cores (3) horizontally. The principle of the design is the same. The difference is top and bottom of the stator core (3) and the leaf (6,13) of the rotor become front and rear, as well as coils (4,19) on them. And front and rear position of the coils (4,19) of the stator core (3) changes as the rotor turning. The connection between the middle coil (20) and front and rear coils (4, 19) is controlled by a PLC. The rotor core (6) and magnet (13) are fixed with no magnetism plates (11). The leafs of the rotor and the principal axis (14) are fixed with two no magnetism plates (8,17) on top and bottom of them. The stator cores (3) with round shape are fixed in the shell (21) by the stator cores seats (33) and bolts (34) on the bottom lid (18).

FIG. 4 shows In a container there are two objects having the same velocity and the same mass, but opposite direction.

FIG. 5 shows big molecule gas is isolated between two sieves, it only allow the tiny molecule of liquid to pass.

FIG. 6 shows the reverse magnetic field dos not counteract each other, but it change gradually in soft magnetic material.

### DETAILED DESCRIPTION OF THE INVENTION

The permanent magnet electrical machinery that does not need any other energy and can be used as an electromotor or a generator consists of a shell (1,21,18) that installed with iron cores (3,6), coils (4,19,20) and principal axis (14), switches (27,25,28,29,31) and a control circuit (FIG. 1, FIG. 2). The shell (1,21,18) consists of a top lid (1), a bottom lid (18) and a shell body (21). The top lid (1), bottom lid (18) and shell body (21) have bolt holes (23) to fit together. The top lid (1) and bottom lid (18) have partition girder (2) to lock stator core (3). The bottom lid (18) and shell body (21) have group holes (22), each group has 2 holes (22) for the wire of the coil (20,4,19) connected to the control circuit. The top lid (1) and bottom lid (18) each have a bearing seat (5, 15) to put the bearing (7, 16). The bottom lid has machine seats (12). The stator core (3) is made by soft magnetic material with the shape of c, and is blocked between top lid (1) and bottom lid (18) by partition girders (2) on each side. There are 3 coils (20, 4, 19) in the middle, top and bottom of the stator core (3) separately. The coil (20) in the middle of the stator core (3) has a distance with the coil (4) on the top part of the stator core (3) and with the coil (19) on bottom part of the stator core (3). The coil (4) on the top part of the stator core (3) is at the top end of the stator core (3) and can be divided to two parts (4a,4b). The coil (19) on bottom part of the stator core (3) is at the bottom end of the stator core (3) and can be divided to two parts (19a,19b). The principal axis (14) is in the symmetry center of the machine, and it circumrotates in the bearing (7) of the top lid (1) and bearing (16) of bottom lid (18). The principal axis (14) and the rotor cores (6) are integral whole. The rotor core (6) has leafs and each leaf has a shape of c, it is made by soft magnetism material and is embed with a magnet (13) on each leaf that is fixed with no magnetism plate (12). The magnet (13) can be more and in different location. The turning rotor core (6) cause light-operated switch (9) on or off, deciding the coil (20) in the middle of the stator core connect or disconnect to the coils (4,19) on the top and bottom of the next stator core (3) through the group switch of two (27a,27b). In the group switch of two (27a,27b), one switch (27a) can connect the coil (4) or only one part of coil (4b) on the top of the stator core (3) and the coil (20) in the middle of the stator core (3), one switch (27b) can connect the coil (19) or only one part (19b) of coil (19) on the bottom of the stator core (3) and the coil (4) on the top of the stator core (3). The light-operated switch (9) can be replaced by a electric brush.

To start the permanent magnet electrical machinery, turn the group switch of two (25a,25b) on the start position, this means the group switch of two (25a,25b) turn-on the battery (24) position, turn the group switch of two (25a,25b) to connect the coil (20) in the middle of the stator core (3) to the coil (4) on the top and the coil (19) on the bottom of the next stator core (3) through the group switch of two (27a,27b). In the group switch of two (27a,27b), one switch (27a) connect the coil (4) on the top of the stator core (3) and the coil (20) in the middle of the stator core (3), one switch (27b) connect the coil (19) on the bottom of the stator core (3) and the coil (4) on the top of the stator core (3). When turning the rotor core (6) is entering into the position to face with stator core (3), it turn-on the light-operated switch (9), connecting the battery (32) and the series-wound coils (4,19) on the top and bottom of the next stator core (3) through the group switch of two (27a,27b). The rotor core (6) run by the magnetic force of the coils (4,19) on the top and bottom of the next stator core (3).

To operate the permanent magnet electrical machinery as a generator after it starts, turn the group switch (25a,25b) off the start position; and turn the group switch (25a,25b) on to the operation position, connecting the coil (20) in the middle of the stator core (3) to the one part of coils (4b,19b) on the top and bottom of the next stator core (3) through the group switch of two (27a,27b). When one leaf of the rotor core (6) is entering into the position to face with stator core (3), due to the increasing magnetic flux in the stator core (3), electric current is produced in the coil (20) in the middle of stator core (3) (at the same time, the series-wound coils (4,19) on the top and bottom of the same stator core (3) are disconnected to the coil (20) in the middle of the upper stator core (3)), the direction of its magnetic flux is opposite to that of the magnets (13). Due to the magnetic flux of reverse magnetic field changes gradually in soft magnetic material (affix 2), the gravitation between the end of the rotor core (6) and the end of the stator core (3) still exists. At the same time, the light-operated switch (9) connect the coil (20) in the middle of stator core (3) to one part of coil (4b,19b) on the top and bottom of the next stator core (3) through the group switch of two (27a,27b) and its magnetic force of electric current repulses next leaf of the rotor core (6), so the rotor core (6) turns continually and the permanent magnet electrical machinery export electricity passing through the rectification and voltage stabilizer (26) continually. To operate the permanent magnet electrical machinery as a motor after it starts, the only different is connecting the coil (20) in the middle of the stator core (3) to the whole coils (4,19) on the top and bottom of the next stator core (3) through the group switch of two (27a,27b).

To modify the permanent magnet electrical machinery, the ratio of leafs of the rotor core (6) and stator cores (3) can be 2:3 or 3:2. The permanent magnet electrical machinery can be putted perpendicularly or horizontally by changing the position of the machine seats (12). Stator cores (3) and leafs of the rotor core (6) can be more. All switches can be instead by a PLC. The light-operated switch (9) can be replaced by the electric brushes.

In the scheme, the ratio of leafs of the rotor core (6) and stator cores (3) is 2:3 or 3:2; the coil (20) in the middle of the stator core (3) can connect or disconnect to the coils (4,19) on the top and bottom of the next stator core (3). Another scheme for the number of leafs of the rotor core (6) and number stator cores (3) is that the number of stator cores (3) is the number of leafs of the rotor core (6) plus 1 or minus 1; the coil (20) in the middle of the stator core (3) can connect or disconnect to the coils (4,19) on the top and bottom of the a stator core (3) decided by a PLC, according to the coil (20) in the middle of the stator core (3) that the rotor core (6) entering to face connected to the coils (4,19) on the top and bottom of the a stator core (3) that the rotor core (6) withdrawing from.

Another scheme for the position of the rotor core (6) and stator cores (3) is to put the rotor core (6) and stator cores (3) horizontally (FIG. 4). The principle of the design is the same. The difference is top and bottom of the stator core (3) and the rotor core (6) become front and rear, as well as coils (4,19) on them. And front and rear position of the coils (4,19) of the stator core (3) changes as the rotor core (6) turning. The connection between the middle coil (6) and front and rear coils (4, 19) is controlled by a PLC. The rotor core (6) and magnet (13) are fixed with two no magnetism plates (8,17) on top and bottom of them. The stator cores (3) with round shape are fixed in the shell (21) by the stator cores seats (33) and bolts (34) on the bottom lid (18).

The features of the invention are no other energy needed, no pollution, simple structure and economical.

1. The invention is a permanent magnet electrical machinery, that is characterized by it is consists of a shell that installed with iron cores, coils, principal axis, switches and a control circuit, the shell consists of a top lid, a bottom lid and a shell body; the top lid has a bearing seat, bolt holes and partition girders to lock stator cores; the bottom lid has a bearing seat, bolt holes, partition girders to lock the stator core and holes for wire and machine seats; the shell body also has bolt holes on each side to fix the top lid, the bottom lid and itself together; it also has holes on the bottom for wire; the iron cones consists of stator cores and rotor cores; the stator cores are made by soft magnetism material with the shape of c; the 3 coils are circled in the middle, top and bottom part of the stator core separately; the coil on the top part of the stator core is at the top end of the stator core and can be divided to two parts; the coil on bottom part of the stator core is at the bottom end of the stator core and can be divided to two parts; the principal axis is installed in the bearing in the top lid and the bearing in the bottom lid; the principal axis and the rotor core are integral whole; the rotor core has leafs and each leaf has a shape of c; it is made by soft magnetism material and is embed with a magnet on each leaf that is fixed with no magnetism plate; the magnet can be more and different location; the turning rotor core cause light-operated switch on or off; light-operated switch connect or disconnect the coil in the middle of the stator core to the coils on the top and bottom of the next stator core through the group switch of two; one switch can connect coil or only one part of coil on the top of the stator core and the coil in the middle of the stator core; one switch can connect coil or only one part of coil on the bottom of the stator core and the end of coil on the top of the stator core; the group switch of two with three positions, the start, operation and stop positions; the permanent magnet electrical machinery started by a battery charged by the permanent magnet electrical machinery itself.

2. According to the claim (1), the permanent magnet electrical machinery is characterized by the coil in the middle of the stator core has a distance with the top end of the stator core and a distance with the bottom end of the stator core.

3. According to the claim (1), the permanent magnet electrical machinery is characterized by the ratio of leafs of the rotor core and stator cores is either 2:3, or 3:2.

4. According to the claim (1), the permanent magnet electrical machinery is characterized by the permanent magnet electrical machinery is operated by electricity that is generated by itself.

5. According to the claim (1), the permanent magnet electrical machinery is characterized by the permanent magnet electrical machinery can be used as an electromotor or a generator.

6. According to the claim (1), the permanent electrical machinery is characterized by the permanent magnet electrical machinery can be putted perpendicularly or horizontally by changing the position of the machine seat.

7. According to the claim (1), the permanent magnet electrical machinery is characterized by stator cores and leafs of the rotor core can be more.

8. According to the claim (1), the permanent magnet electrical machinery is characterized by the light-operated switch can be replaced by the electric brushes.

9. According to the claim (1), the permanent magnet electrical machinery is characterized by Another scheme for the number of leafs of the rotor core and stator cores is that the number of stator cores is the number of leafs of the rotor core plus 1 or minus 1.

10. According to the claim (9), the permanent magnet electrical machinery is characterized by that the coil in the middle of the stator core can connect or disconnect to the coil on the top and bottom of the a stator core through a PLC, according to that the coil in the middle of the stator core that the rotor core entering to face connected to the coil on the top and bottom of the stator core that the rotor core withdrawing from.

11. According to the claim (1), the permanent magnet electrical machinery is characterized by Another scheme for the position of the rotor core and stator cores is to put the rotor core and stator cores horizontally (FIG. 4) with the same principle of the design.

12. According to the claim (11), the permanent magnet electrical machinery is characterized by the top and bottom of the stator core and the rotor core become front and rear, as well as coils on them.

13. According to the claim (11), the permanent magnet electrical machinery is characterized by front and rear position of the coils of the stator core changes as the rotor core turning.

14. According to the claim (11), the permanent magnet electrical machinery is characterized by the connection between the middle coil and front and rear coils is controlled by a PLC.

15. According to the claim (11), the permanent magnet electrical machinery is characterized by the rotor core and magnet are fixed with two no magnetism plates on top and bottom of them.

16. According to the claim (11), the permanent magnet electrical machinery is characterized by the stator cores with round shape are fixed in the shell by the stator cores seats and bolts on the bottom lid.
